(19) United States
(12) Patent Application Publication
(10) Pub. No.: US 2011/0085924 A1
(43) Pub. Date: Apr. 14, 2011

(54) PUMP ASSEMBLY VIBRATION ABSORBER SYSTEM

(76) Inventors: Rod Shampine, Houston, TX (US); Rajesh Luharuka, Stafford, TX (US); Edward Leugemors, Needville, TX (US); Laurent Coquilleau, Houston, TX (US)

(21) Appl. No.: 12/881,533

(22) Filed: Sep. 14, 2010

Related U.S. Application Data
(60) Provisional application No. 61/250,280, filed on Oct. 9, 2009.

(51) Int. Cl. F16F 7/10; B23P 11/00; F04B 17/00

(52) U.S. Cl. 417/321; 29/428; 188/379

(57) ABSTRACT

The vibration of a pump assembly, comprising a prime mover, a multiplex fluid pump connected to a drive line, and a transmission connected to transfer torque from the prime mover to the drive line to reciprocate a plurality of plungers, and a source of harmonic excitation, is inhibited by coupling a counteracting resonant system to the pump assembly, wherein the counteracting resonant system has an oscillatory frequency matching the harmonic excitation source. Also disclosed are a pump assembly comprising the prime mover, the multiplex fluid pump, the drive line, the transmission, and the counteracting resonant system; and a pumping method comprising connecting the transmission to transfer torque from the prime mover to rotate the drive line, connecting the drive line to the multiplex fluid pump, and coupling and tuning the counteracting resonant system to the induced harmonic excitation.

### CROSS REFERENCE TO RELATED APPLICATION(S)

This application claims the benefit of and priority to provisional application US 61/250,280, filed Oct. 9, 2009.

### STATEMENT REGARDING FEDERALLY SPONSORED RESEARCH OR DEVELOPMENT

Not applicable

### THE NAMES OF PARTIES TO A JOINT RESEARCH AGREEMENT

Not applicable

INCORPORATION BY REFERENCE OF MATERIAL SUBMITTED ON A COMPACT DISC

Not applicable

### BACKGROUND OF THE INVENTION

(1) Field of the Invention

The invention is related in general to pumps such as, but not limited to, fracturing pumps, for example, at the wellsite surface location, and the like.

(2) Description of Related Art Including Information Disclosed under 37 CFR 1.97 and 1.98

Hydraulic fracturing of downhole formations is a critical activity for well stimulation and/or well servicing operations. Typically this is done by pumping fluid downhole at relatively high pressures so as to fracture the rocks. Production fluids and/or gases can then migrate to the wellbore through these fractures and significantly enhance well productivity. Triplex and quintuplex reciprocating pumps are generally used to pump the high pressure fracturing fluid downhole. Typically, the pumps that are used for this purpose have plunger sizes varying from 95 mm (3.75 in.) to 165 mm (6.5 in.) in diameter and operate at pressures up to 140 MPa (20,000 psi (20 ksi)).

A fracturing pump typically consists of four main components: the prime mover or engine, the transmission, the drive line, and the pump. The pump assembly is comprised of two major sub-assemblies—power end and fluid end. The power end includes crank slider mechanism that reciprocates the plungers inside the fluid end, which is a container that holds and discharges pressurized fluid with the pump plungers.

In triplex pumps, the fluid end has three fluid cylinders. For the purpose of this document, the middle of these three cylinders is referred to as the central cylinder, and the remaining two cylinders are referred to as side cylinders. Similarly, a quintuplex pump has five fluid cylinders, including a middle cylinder and four side cylinders.

The pumping cycle of the fluid end is composed of two stages: (a) a suction cycle: During this part of the cycle, a piston moves outward in a packing bore, thereby lowering the fluid pressure in the fluid end. When the fluid pressure is less than the pressure of the fluid in a suction pipe, typically 2-3 times the atmospheric pressure, approximately about 290 kPa (40 psi), the suction valve opens and the fluid end is filled with pumping fluid; and (b) a discharge cycle: During this cycle, the plunger moves forward in the packing bore, thereby progressively increasing the fluid pressure in the pump and closing the suction valve. At a fluid pressure slightly higher than the line pressure, which can range from as low as 14 MPa (2 ksi) to as high as 140 MPa (20 ksi), the discharge valve opens, and the high pressure fluid flows through the discharge pipe.

In fracturing pumping service, large vibrations may be encountered that may lead to damage to pumps, transmissions, and engines. A first order approximation of the pump assembly is to assume the pump may be modeled as a simple flywheel with torque pulsations applied to it, the driveshaft may be modeled as a simple torsional spring, and the transmission supplies a torque with small pulsations overlaid on it. In this model, the pump's rotating mass forms a resonant system with the drive line. When a driving frequency (such as the plunger frequency and its multiples) coincides with the first, second, or third resonant mode of this system, large torque fluctuations are seen in the driveline of the assembly. If the torque fluctuations are less than the prevailing pumping torque, the gears in the transmission and pump stay in contact. When the torque fluctuations exceed the magnitude of the prevailing torque and/or go negative, however, the gear teeth in the transmission and/or the pump will go in and out of contact at the driving frequency with associated impact loads. These impact loads from the alternating contacting gear teeth produce huge stresses and may destroy a transmission very quickly. In the case of standard triplex pumps, this process may occur just above 1600 L/min (10 barrels per minute (BPM)) of pumping rate. Above 1600 L/min (10 BPM), the plunger frequency coincides with a shaft/pump mass resonance, and the transmission will fail. It has been shown that reducing dynamic torque amplitudes under normal operating conditions greatly improves the transmission life on the pumper, due to reduced cyclic loading of the drivetrain and resulting in prolonged life of the stress-bearing members.

Some of the issues associated with such vibration and/or torque fluctuations may be addressed with tougher/heavier duty transmissions, viscous dampeners, and/or harmonic balancers. A typical vibration damper or harmonic balancer is attached to a prime mover and may comprise a ring shaped mass disposed inside a ring shaped housing with oil between them. The housing is attached to the pump input shaft and rotates. When the shaft is turning steadily, there is no motion between the mass and the housing. When the shaft speed varies, the mass moves relative to the housing and energy is dissipated in the oil.

It remains desirable to provide improvements in wellsite surface equipment in efficiency, flexibility, reliability, and maintainability.

### BRIEF SUMMARY OF THE INVENTION

In one embodiment, a pump assembly comprises a prime mover, a multiplex fluid pump connected to a drive line, a transmission connected to transfer torque from the prime mover to rotate the drive line, a source of harmonic excitation originating from one or a combination of any of the prime mover, the multiplex fluid pump, driveline and transmission, preferably from at least one of the multiplex fluid pump, driveline and transmission and a counteracting resonant system coupled to the harmonic excitation source.

The system components giving rise to the harmonic excitation may be referred to herein as a primary resonant system, and the counteracting resonant system may also be referred to herein as an auxiliary resonant system. A counteracting resonant system is one that is synchronized with the primary resonant system but has a displacement component opposite a displacement component of the primary resonant system such that vibration is inhibited, the resonant frequency is altered, or the like. In one embodiment, where synchronization is achieved by coupling the primary and counteracting resonant systems via a rotating shaft, the resonant systems are balanced to inhibit vibration and/or to increase the speed of rotation at which excessive vibration occurs.

In an embodiment, the counteracting resonant system has an oscillatory frequency matching an oscillatory frequency of the harmonic excitation source.

In an embodiment, the harmonic excitation source and the counteracting resonant system have matching resonant frequencies. In an embodiment, the counteracting resonant system absorbs fluctuations in torque transferred between the prime mover and the multiplex fluid pump, preferably inhibiting the torque fluctuations up to or above a predetermined magnitude.

In an embodiment, the counteracting resonant system comprises a mirrored pump and drive shaft having a resonant frequency harmonically matched with respect to the multiplex fluid pump. A mirrored pump is one that has similar components to the main or primary pump, but their position with respect to an axis of the drive line is generally opposite that of the mirrored pump as if reflected with respect to a plane containing the axis. In an embodiment, the mirrored pump and drive shaft are substantially identical with respect to the multiplex fluid pump and drive line of the primary resonant system. In one embodiment, the counteracting resonant system comprises a mirrored pump and drive shaft connecting the mirrored pump to the multiplex fluid pump, and in another connecting the mirrored pump to the transmission.

In an embodiment, the counteracting resonant system comprises a tuned mass-spring system. In various embodiments, the tuned mass-spring system comprises a variable inertia flywheel, a rotating pendulum, a bifilar pendulum, a roller-type pendulum, a ring-type pendulum, a harmonic balancer, or a combination thereof.

In an embodiment, the tuned mass-spring system comprises another multiplex fluid pump connected to a drive shaft to mirror the primary resonant system. In embodiments, the multiplex fluid pump of the tuned mass-spring system is loaded (pumping fluid) or unloaded (“pumping” air).

In one embodiment, a pumping method comprises connecting the transmission to transfer torque from the prime mover to rotate the drive line, connecting the drive line to the multiplex fluid pump to reciprocate a plurality of plungers in a like plurality of cylinders to discharge a pressurized fluid from the pump, wherein one or a combination of the torque transfer, the drive line rotation and the plunger reciprocation induces harmonic excitation at one or more variable oscillating frequencies, coupling a counteracting resonant system to the prime mover, the transmission, the driveline, the multiplex fluid pump, or a combination thereof, and tuning the counteracting resonant system to the induced harmonic excitation. For example, the multiplex fluid pump and the drive line can define a primary resonant system having an oscillating frequency depending on a rotational speed of the drive line. In an embodiment, the method can include inhibiting a torsional component of the induced harmonic excitation.

In one embodiment, a method is provided to inhibit vibration of a pump assembly comprising a prime mover, a multiplex fluid pump connected to a drive line, and a transmission connected to transfer torque from the prime mover to rotate the drive line and reciprocate a plurality of plungers in a like plurality of cylinders in the fluid pump to discharge a pressurized fluid from the pump. The method comprises coupling a counteracting resonant system to the pump assembly, wherein the counteracting resonant system has an oscillatory frequency matching an oscillatory frequency matching an oscillatory frequency of the harmonic excitation source.

### BRIEF DESCRIPTION OF THE SEVERAL VIEWS OF THE DRAWINGS

FIG. 1 is a schematic diagram of a pump assembly according to an embodiment wherein dual pumps are connected together.

FIG. 2 is a schematic diagram of a pump assembly according to an alternate embodiment wherein dual pumps are connected to a common transmission.

FIG. 3 is a schematic diagram of a pump assembly according to an embodiment wherein an auxiliary resonant system is connected between a transmission and a pump.

FIG. 4 is a schematic diagram of a simple pendulum according to an embodiment.

FIG. 5A is a schematic diagram of a bifilar pendulum according to an embodiment.

FIG. 5B is a schematic end view of a disk-shaped element including bifilar pendulums according to an embodiment.

FIG. 5C is a schematic sectional side view of a bifilar pendulum according to an embodiment.

FIG. 6A is a schematic diagram of a roller-type pendulum according to an embodiment.

FIG. 6B is a schematic sectional side view diagram of a roller-type pendulum according to an embodiment.

FIG. 6C is a schematic sectional side view diagram of a roller-type pendulum according to another embodiment.

FIG. 6D is a schematic diagram of a roller-type or ball-type pendulum according to an embodiment.

FIG. 7A is a schematic diagram of a ring-type pendulum according to an embodiment.

FIG. 7B is a schematic sectional side view diagram of a ring-type pendulum according to an embodiment.

FIG. 8A is a schematic diagram of a composite-type pendulum according to an embodiment.

FIG. 8B is a schematic sectional side view diagram of a composite-type pendulum according to an embodiment.

FIG. 9 is a schematic diagram of a rotating pendulum vibration absorber according to an embodiment.

FIG. 10 is a schematic diagram of a variable inertia fly wheel according to an embodiment.

FIG. 11 is a schematic sectional diagram of stacked vibration absorbers according to an embodiment.

### DETAILED DESCRIPTION OF THE INVENTION

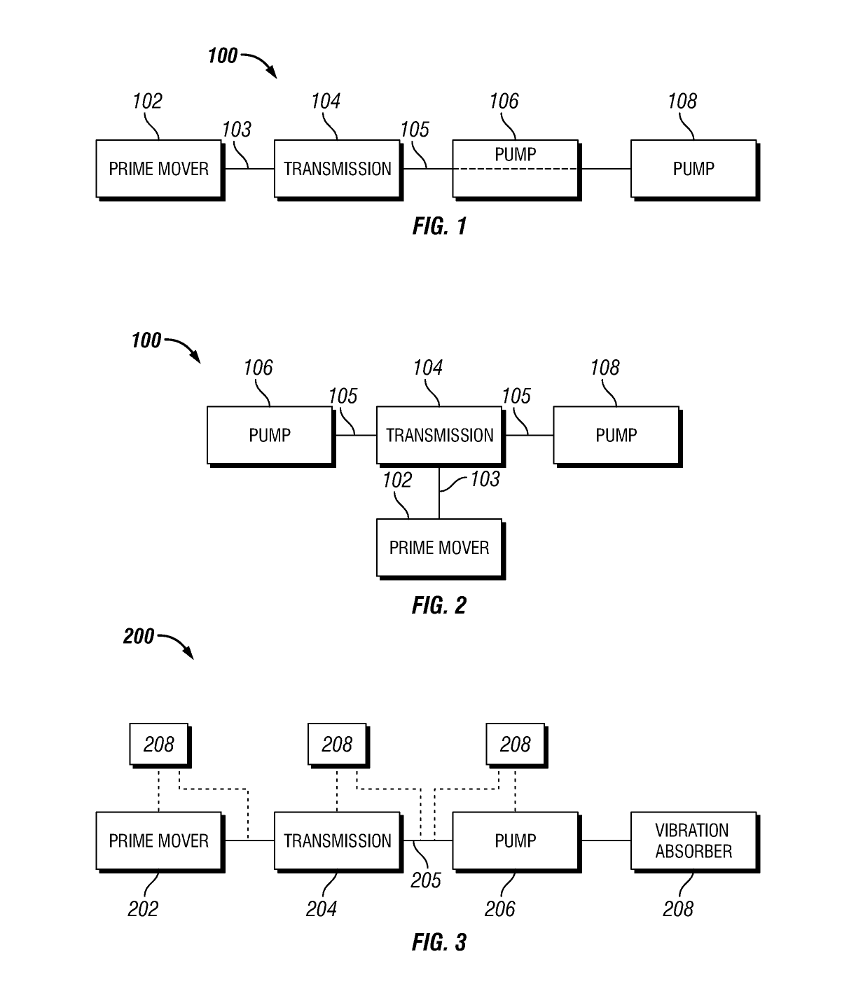

Referring now to FIGS. 1 and 2, there is disclosed a pump assembly, indicated generally at 100. The pump assembly 100 comprises a prime mover 102, such as a diesel engine, a gasoline engine, an electric motor, or any suitable prime mover. The prime mover 102 is coupled to a transmission 104 via a suitable connection such as a driveshaft 103 or the like, which is further coupled to a pair of pumps 106 and 108 via a suitable connection such as a driveshaft or driveshafts 105 or the like. The pumps 106 and 108 may be coupled to the transmission 104 in series, as seen in FIG. 1, or in parallel, as seen in FIG. 2. In such a system 100, the resonant frequency of the first drive shaft 105 and the first pump 106 or 108 matches that of the second drive shaft 105 and the second pump 106 or 108.

A typical system comprises a prime mover 102, a transmission 104, and a single pump 106 or 108. During testing, it has been found that at the speed where a single triplex/single drive shaft system approach 100% torque fluctuations (between 1.6-2.2 cubic meters (10-14 42-gal barrels) per minute pumping rate at a pump speed of 220-300 revolutions per minute), the system 100 comprising two triplexes 106 and 108 (with triplex 108 running unloaded only as a flywheel) and two drive shafts only had less than 50% torque fluctuations. After further investigation, it was determined that the second pump 106 or 108 and the second shaft acted as a tuned vibration absorber for the pump assembly 100, and the reduced torque fluctuations were not due to a shift in the resonance due to the additional mass or due to the smaller torque pulsations from using two pumps 106 and 108 with the correct phasing.

Referring now to FIG. 3, there is disclosed a pump assembly, indicated generally at 200. The pump assembly 200 comprises a prime mover 202, such as a diesel engine, a gasoline engine, an electric motor, or any suitable prime mover. The prime mover 202 is coupled to a transmission 204, which is further coupled to pump 206. Considering the shaft 205 and pump 206 as a primary resonant system, a vibration absorber 208 comprising an auxiliary resonant system is coupled adjacent the pump 206 for absorbing torque fluctuations from the pump 206 and preventing torque fluctuations of a predetermined magnitude from being transmitted to the prime mover 202 or the transmission 204. The vibration absorber 208 may be coupled and/or installed on any location on the assembly 200 where it is advantageous to absorb torque fluctuations. Those skilled in the art will appreciate that the vibration absorber 208 may also be coupled to a system 100 comprising the transmission 104 and the pumps 106 and 108 of FIGS. 1 and 2, and/or that the vibration absorber 208 can be or include a mirrored pump system as shown in FIGS. 1 and 2 or an equivalent torsional spring and inertia system.

In an embodiment, the vibration absorber 208 comprises a dedicated mass and spring dampener tuned to the right frequency. The mass and spring dampener preferably comprises a predetermined amount of mass such that absorbing and returning energy at the resonant frequency does not over-stress the spring element. This may be accomplished at a lower total mass than a pump with careful design. Additionally, the mass element may comprise a torsional vibration damper or harmonic balancer as described herein to further improve the performance. In an embodiment, the vibration absorber 208 comprises a harmonic balancer, as described herein.

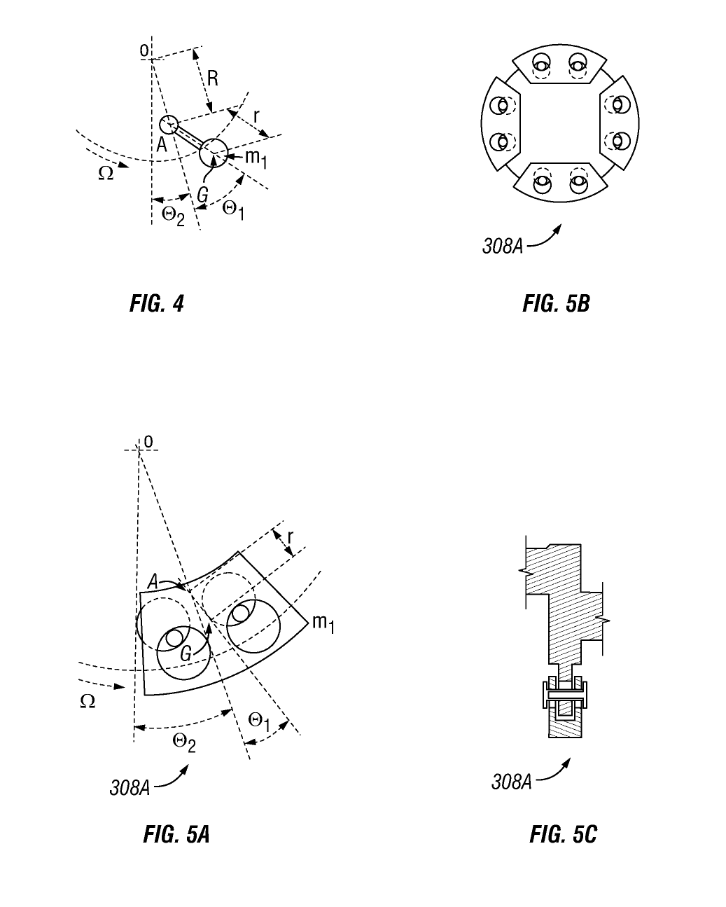

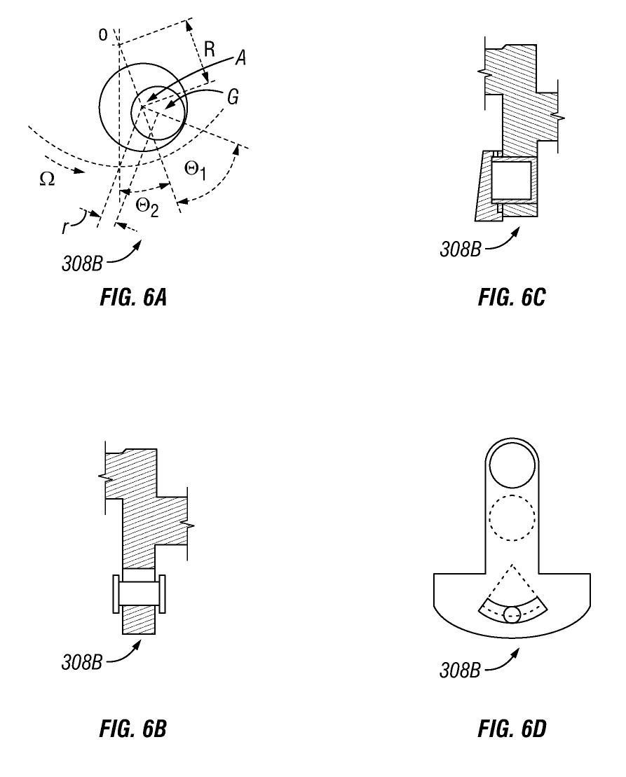

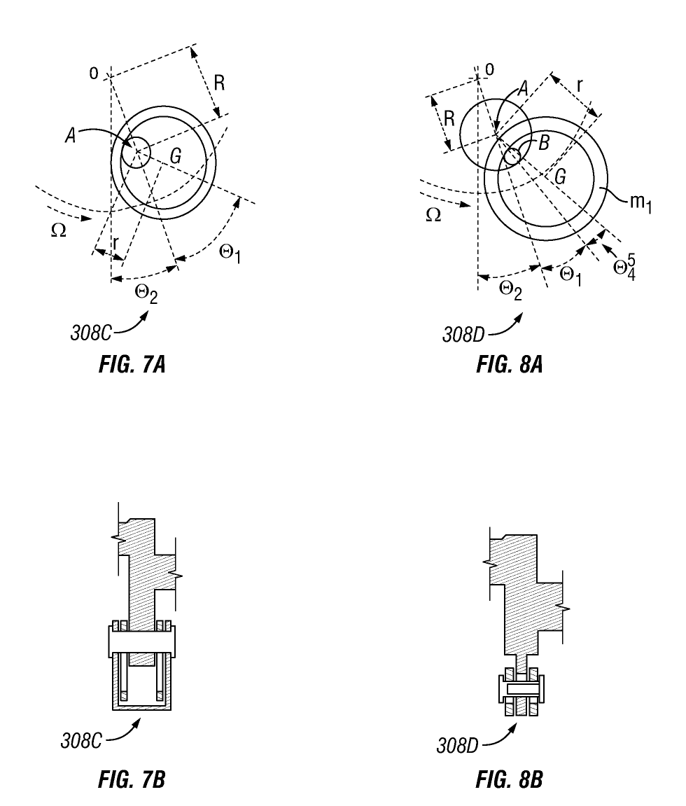

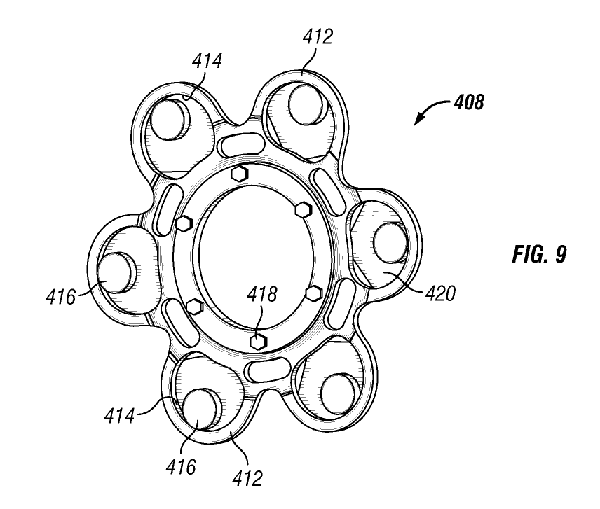

In an embodiment, the vibration absorber 208 comprises a rotating pendulum vibration absorber, as described in Nestorides, E. J., A handbook on torsional vibration, British Internal Combustion Engine Research Association, p. 582 (1958), which is hereby incorporated herein by reference. In embodiments seen in FIGS. 4 to 10, the vibration absorber comprises a bifilar type pendulum vibration absorber 308A, a roller-type pendulum vibration absorber 308B, a ring-type pendulum vibration absorber 308C, a composite-type pendulum vibration absorber 308D or any suitable pendulum vibration absorber. The rotating pendulum vibration absorbers 308A, 308B, 308C, and 308D each are operable to absorb vibration and/or torque fluctuations from the pump 206 and inhibit or prevent torque fluctuations of a predetermined magnitude from being transmitted to the prime mover 202 or transmission 204.

The rotating pendulum vibration absorbers 308A, 308B, 308C, and 308D each provide a tuned vibration absorber whose frequency is related to shaft speed and may be chosen to damp a specific multiple of shaft speed or the pump speed. In an embodiment, a multiple is three times the ratio of the gear reduction in the pump power end corresponding to the frequency of the plunger pulses, so that the plunger pulses are damped. In an embodiment, the vibration absorber 208 is operable to attenuate and/or absorb multiple vibration modes, such as three, six, nine, twelve, and fifteen for a triplex pump and five, ten, fifteen, and twenty for a quintuplex pump. This may be accomplished by stacking multiple rotating pendulum vibration absorbers 308A, 308B, 308C, and 308D or by providing such a capability into a single vibration absorber 208. In an embodiment, a disk-type crankshaft incorporates damping elements in a manner similar to engine applications. This may increase the weight, which is a concern in some applications, but effectively reduces the shaking caused by the reciprocating masses.

In an embodiment, referring now to FIG. 9, the vibration absorber 208 comprises a rotating pendulum vibration absorber 408. The vibration absorber 408 comprises a body 410 having a plurality of arcuate projections 412 extending therefrom. Each of the projections 412 define an inner surface 414 that each engage with a respective disk 416 disposed therein. The body 410 may be attached to a component of the system 200, such as the pump 206 by a plurality of fasteners 418. The projections 412 may further comprise a cover 420 on opposite sides thereof for enclosing the disk 416 within the projection 412 and further protecting the enclosed area from foreign object damage and the like. Enclosed within the projections 412, the disks 416 are free to engage with the respective surface 414 and perform similar to the roller-type pendulum 308C. As noted above, the disks 416 may be chosen to absorb and/or attenuate torque fluctuations and/or vibrations of multiple modes. In a non-limiting example, there are shown six disks 416 in FIG. 9. Three of the disks 416 may be sized to absorb and/or attenuate third order torque fluctuations and/or vibrations and the other three of the disks 416 may be sized to absorb and/or attenuate sixth order torque fluctuations and/or vibrations, as will be appreciated by those skilled in the art.

The rotating pendulum vibration absorbers 308A, 308B, 308C, 308D, and/or 408 may be advantageously added to a pump assembly 200 as a retrofit solution to reduce overall torque fluctuations from the pump 206 to the remainder of the elements in the pump assembly 200.

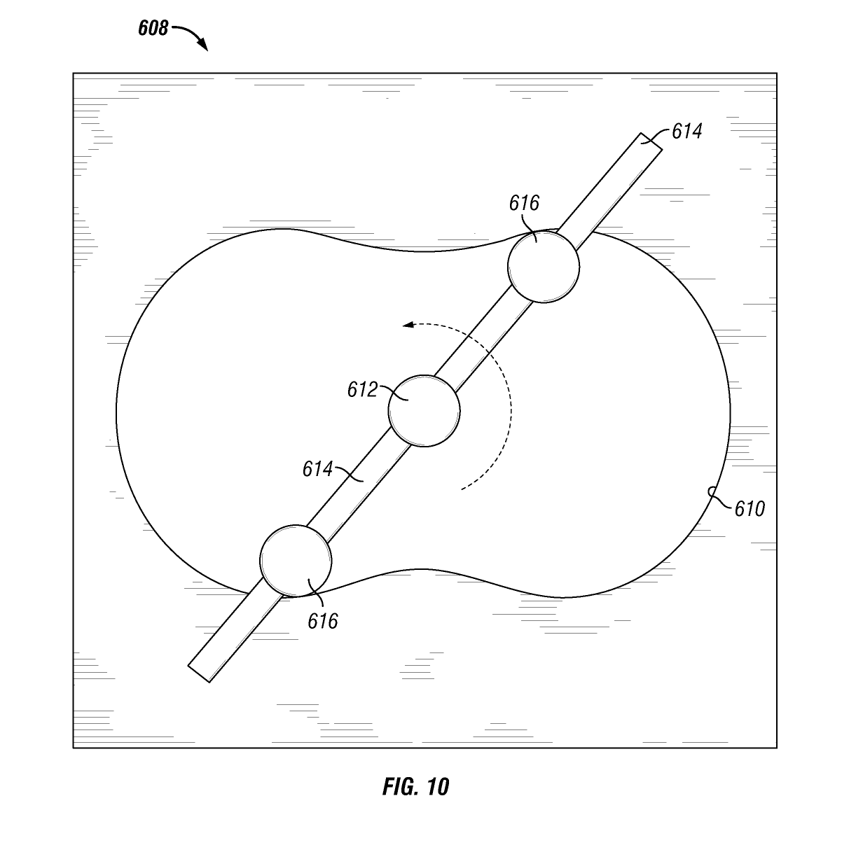

In an embodiment, best seen in FIG. 10, the vibration absorber 208 comprises a variable inertia fly wheel, indicated generally at 608. The variable inertia fly wheel 608 comprises a hollow generally peanut-case-shaped cam 610, which is a fixed body. A rotating shaft 612 having a pair of arms 614 attached thereto is disposed within the cam 610. On each arm 614 is disposed a sliding weight 616. During operation the sliding weights 616 are pushed against the walls of the cam 610 by centrifugal force. The weights 616 may have rollers or similar devices to limit friction during travel. In a 180° half turn the weights 616 will move synchronously closer and farther from the axis of rotation around the shaft 612. Since inertia is mass times radius squared, by changing the radius (i.e. the radial length of the arms 614), the inertia of the complete system, such as the assembly 200, may be controlled. Regarding synchronization, this system may be geared in such a way that it does half a turn for each plunger cycle (i.e. for a triplex, the system completes half a turn in a third of a turn for the crankshaft). The variable inertia fly wheel 608 advantageously provides the opportunity to exactly control the amount of inertia existing at a specific point in the cycle.

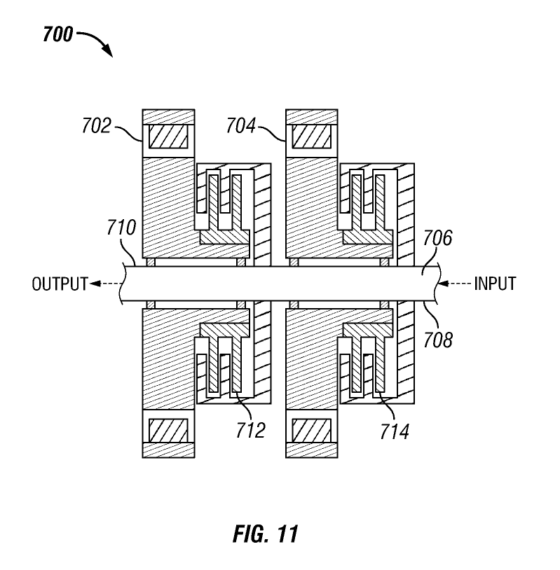

In an embodiment, best seen in FIG. 11, a stacked vibration absorption system 700 includes a plurality of rotary vibration absorbers 702 and 704 coaxially mounted with the rotatable shaft 706 adapted to receive torque at the input side 708 and transfer torque at the output side 710. A plurality of optional clutches 712, 714 can, if desired, be selectively engaged or disengaged to couple the respective vibration absorber 702, 704 to the rotation of the shaft 706. While two clutchable vibration absorbers 702, 704 are illustrated for clarity and convenience, the vibration absorbers can be clutched or non-clutched and any number other than two can be employed.

The system 700 shown in FIG. 11 is advantageous for use were multiple harmonics cannot be damped with a single design vibration absorber, or where a single vibration absorber is undesirable. For example, in an embodiment, the vibration absorbers 702, 704 can be clutched based on the gear used in the transmission. With stacked vibration absorbers, in an embodiment, the magnitude of torque fluctuation can be adjusted, e.g., increased and/or decreased depending on the magnitude of the torque fluctuation and/or the magnitude of the vibratory displacements. In one embodiment, the stacked vibration absorbers can have closely spaced resonance frequencies whereby a correspondingly widened range of band stop frequency can be achieved.

Accordingly, the present invention provides the following embodiments:

A. A pump assembly, comprising:
a prime mover;
a multiplex fluid pump connected to a drive line;
a transmission connected to transfer torque from the prime mover to rotate the drive line;
a source of harmonic excitation originating from one or a combination of any of the prime mover, the multiplex fluid pump, driveline and transmission; and
a counteracting resonant system coupled to the harmonic excitation source, wherein the counteracting resonant system has an oscillatory frequency matching an oscillatory frequency of the harmonic excitation source to inhibit vibration.
   B. The pump assembly of embodiment A, wherein the harmonic excitation source and the counteracting resonant system have matching resonant frequencies.
   C. The pump assembly of embodiment A or embodiment B, wherein the counteracting resonant system absorbs fluctuations in torque transferred between the prime mover and the multiplex fluid pump.
   D. The pump assembly of any one of embodiments A to C, wherein the counteracting resonant system inhibits the torque fluctuations above a predetermined magnitude.
   E. The pump assembly of any one of embodiments A to D, wherein the counteracting resonant system inhibits the torque fluctuations up to a predetermined magnitude.
   F. The pump assembly of any one of embodiments A to E, wherein the counteracting resonant system comprises a mirrored pump and drive shaft having a resonant frequency matching a resonant frequency of the harmonic excitation source.
   G. The pump assembly of any one of embodiments A to F wherein the counteracting resonant system comprises a mirrored pump harmonically matched with respect to the multiplex fluid pump.
   H. The pump assembly of any one of embodiments A to G, wherein the counteracting resonant system comprises a mirrored pump and drive shaft connecting the mirrored pump to the multiplex fluid pump.
   I. The pump assembly of any one of embodiments A to G, wherein the counteracting resonant system comprises a mirrored pump and a drive shaft connecting the mirrored pump to the transmission.
   J. The pump assembly of any one of embodiments A to I, wherein the counteracting resonant system comprises a tuned mass-spring system.
   K. The pump assembly of embodiment J, wherein the tuned mass-spring system comprises a variable inertia flywheel.
   L. The pump assembly of embodiment J or embodiment K, wherein the tuned mass-spring system comprises a rotating pendulum.
   M. The pump assembly of any one of embodiments J to L, wherein the tuned mass-spring system comprises a bifilar pendulum.
   N. The pump assembly of any one of embodiments J to M, wherein the tuned mass-spring system comprises a roller-type pendulum.
   O. The pump assembly of any one of embodiments J to N, wherein the tuned mass-spring system comprises a ring-type pendulum.
   P. The pump assembly of any one of embodiments J to O, wherein the tuned mass-spring system comprises a harmonic balancer.
   Q. The pump assembly of any one of embodiments J to P, wherein the tuned mass-spring system comprises a mirroring multiplex fluid pump connected to a drive shaft to mirror the multiplex fluid pump of the harmonic excitation source.
   R. The pump assembly of embodiment Q, wherein the mirroring multiplex fluid pump of the tuned mass-spring system is unloaded.
   S. The pump assembly of embodiment Q, wherein the mirroring multiplex fluid pump of the tuned mass-spring system is loaded.
   T. The pump assembly of any one of embodiments A to S, comprising a plurality of harmonic excitation sources having a like plurality of resonant frequencies, wherein the counteracting resonant system comprises a plurality of stacked vibration absorbers each having an oscillatory frequency matching an oscillatory frequency of one of the harmonic excitation sources.
   U. The pump assembly of embodiment T, wherein the stacked vibration absorbers are coupled to the harmonic excitation sources by clutches.
   V. The pump assembly of any one of embodiments A to U, wherein the transmission comprises a plurality of selectable gears, wherein the counteracting resonant system comprises a plurality of stacked vibration absorbers coupled to the transmission, and wherein one or more of the stacked vibration absorbers are clutched based on the gear selected in the transmission.
   W. The pump assembly of any one of embodiments A to V, wherein the counteracting resonant system absorbs fluctuations in torque transferred between the prime mover and the multiplex fluid pump, and wherein the counteracting resonant system comprises a plurality of stacked vibration absorbers to selectively adjust a magnitude of torque fluctuation absorption.
   X. The pump assembly of any one of embodiments A to W, wherein the counteracting resonant system comprises a plurality of stacked vibration absorbers to selectively adjust a magnitude of the counteracting oscillatory frequency.
   Y. A pumping method, comprising:
connecting a transmission to transfer torque from a prime mover to rotate a drive line;
connecting the drive line to a multiplex fluid pump to reciprocate a plurality of plungers in a like plurality of cylinders to discharge a pressurized fluid from the pump;
wherein one or a combination of the torque transfer, the drive line rotation and the plunger reciprocation induces harmonic excitation at one or more variable oscillating frequencies;
coupling a counteracting resonant system to the prime mover, the transmission, the driveline, the multiplex fluid pump, or a combination thereof;
varying at least one oscillatory frequency of the counteracting resonant system to match at least one of the one or more variable oscillating frequencies of the induced harmonic excitation.
   Z. The pumping method of embodiment Y, wherein the counteracting resonant system is tuned to the induced harmonic excitation.
   AA. The pumping method of embodiment Y or embodiment Z, wherein the harmonic excitation is induced in whole in part by the multiplex pump.
   BB. The pumping method of any one of embodiments Y to AA, wherein the harmonic excitation is induced in whole in part by the prime mover.
   CC. The pumping method of any one of embodiments Y to AA, wherein the harmonic excitation is induced by the prime mover in combination with one or more of the transmission, the driveline and the multiplex fluid pump.
   DD. The pumping method of any one of embodiments Y to CC, wherein the counteracting resonant system inhibits a torsional component of the induced harmonic excitation.
   EE. The pumping method of embodiment DD, wherein the counteracting resonant system absorbs fluctuations of the torque transferred via the drive line.
   FF. The pumping method of embodiment DD or embodiment EE, wherein the counteracting resonant system inhibits fluctuations above a predetermined magnitude of fluctuations of the torque transferred via the drive line.
   GG. The pumping method of embodiment DD or embodiment EE, wherein the counteracting resonant system inhibits fluctuations up to a predetermined magnitude of fluctuations of the torque transferred via the drive line.
   HH. The pumping method of any one of embodiments Y to GG, wherein the counteracting resonant system comprises a mirrored pump having a resonant frequency matching a resonant frequency of the multiplex fluid pump.
   II. The pumping method of any one of embodiments Y to HH, wherein the counteracting resonant system comprises a mirrored pump and drive shaft harmonically matched with respect to the multiplex fluid pump and drive line.
   JJ. The pumping method of any one of embodiments Y to II, wherein the counteracting resonant system comprises a mirrored pump and drive shaft connecting the mirrored pump to the multiplex fluid pump.
   KK. The pumping method of any one of embodiments Y to JJ, wherein the counteracting resonant system comprises a mirrored pump and a drive shaft connecting the mirrored pump to the transmission.
   LL. The pumping method of any one of embodiments Y to KK, wherein the counteracting resonant system comprises a tuned mass-spring system.
   MM. The pumping method of embodiment LL, wherein the tuned mass-spring system has a plurality of tuning ratios.
   NN. The pumping method of embodiment LL or embodiment MM, wherein the tuned mass-spring system has a plurality of resonance frequencies.
   OO. The pumping method of any one of embodiments LL to NN, wherein the tuned mass-spring system comprises a variable inertia flywheel.
   PP. The pumping method of any one of embodiments LL to OO, wherein the tuned mass-spring system comprises a torsional spring matching the driveline and a rotational inertia matching the multiplex pump.
   QQ. The pumping method of any one of embodiments LL to PP, wherein the tuned mass-spring system comprises a rotating pendulum.
   RR. The pumping method of any one of embodiments LL to QQ, wherein the tuned mass-spring system comprises a bifilar pendulum.
   SS. The pumping method of any one of embodiments LL to RR, wherein the tuned mass-spring system comprises a roller-type pendulum.
   TT. The pumping method of any one of embodiments LL to SS, wherein the tuned mass-spring system comprises a ring-type pendulum.
   UU. The pumping method of any one of embodiments LL to TT, wherein the tuned mass-spring system comprises a harmonic balancer.
   VV. The pumping method of any one of embodiments LL to UU, wherein the tuned mass-spring system comprises another pump connected to a drive shaft to mirror the multiplex fluid pump and the drive line.
   WW. The pumping method of embodiment VV, wherein the mirroring pump of the tuned mass-spring system is unloaded.
   XX. The pumping method of embodiment VV, further comprising pumping fluid with the mirroring pump of the tuned mass-spring system.
   YY. The pumping method of any one of embodiments LL to XX, wherein harmonic excitation is induced at a plurality of different oscillating frequencies, wherein the counteracting resonant system comprises a plurality of stacked vibration absorbers having different oscillatory frequencies, and further comprising selecting and deselecting ones of the vibration absorbers to match an active oscillatory frequency of the harmonic excitation.
   ZZ. The pumping method of embodiment XX, wherein the stacked vibration absorbers are selectively coupled and decoupled by clutches.
   AAA. The pumping method of any one of embodiments Y to ZZ, further comprising selecting one of a plurality of gears in the transmission, wherein the counteracting resonant system comprises a plurality of stacked vibration absorbers coupled to the transmission, and clutching one or more of the stacked vibration absorbers based on the gear selected in the transmission.
   BBB. The pumping method of any one of embodiments Y to AAA, wherein the counteracting resonant system absorbs fluctuations of the torque transferred between the prime mover and the multiplex fluid pump, and wherein the counteracting resonant system comprises a plurality of stacked vibration absorbers, and further comprising selecting and deselecting ones of the plurality of stacked vibration absorbers to adjust a magnitude of the torque fluctuation absorption.
   CCC. The pumping method of any one of embodiments Y to BBB, wherein the counteracting resonant system comprises a plurality of stacked vibration absorbers, and further comprising selecting and deselecting ones of the stacked vibration absorbers to selectively adjust a magnitude of the counteracting oscillatory frequency.
   DDD. A method to inhibit vibration of a pump assembly comprising a prime mover, a multiplex fluid pump connected to a drive line, a transmission connected to transfer torque from the prime mover to rotate the drive line and reciprocate a plurality of plungers in a like plurality of cylinders in the fluid pump to discharge a pressurized fluid from the pump, and a source of harmonic excitation, comprising:

coupling a counteracting resonant system to the pump assembly;

wherein the counteracting resonant system has an oscillatory frequency matching an oscillatory frequency of the harmonic excitation source.

EEE. The method of embodiment DDD, wherein the counteracting resonant system and the pump assembly have matching resonant frequencies.
FFF. The method of embodiment DDD or embodiment EEE, wherein the counteracting resonant system absorbs fluctuations of the transferred torque.
GGG. The method of any one of embodiments DDD to FFF, wherein the counteracting resonant system inhibits the torque fluctuations above a predetermined magnitude.
HHH. The method of any one of embodiments DDD to GGG, wherein the counteracting resonant system inhibits the torque fluctuations up to a predetermined magnitude.
III. The method of any one of embodiments DDD to HHH, wherein the counteracting resonant system comprises a mirrored pump harmonically matched with respect to the multiplex fluid pump.
JJJ. The method of any one of embodiments DDD to III, wherein the counteracting resonant system comprises a mirrored pump and drive shaft harmonically matched with respect to the multiplex fluid pump and drive line.
KKK. The method of any one of embodiments DDD to JJJ, wherein the counteracting resonant system comprises a mirrored pump and drive shaft connecting the mirrored pump to the multiplex fluid pump.
LLL. The method of any one of embodiments DDD to KKK, wherein the counteracting resonant system comprises a mirrored pump and a drive shaft connecting the mirrored pump to the transmission.
MMM. The method of any one of embodiments DDD to LLL, wherein the counteracting resonant system comprises a tuned mass-spring system.
NNN. The method of embodiment MMM, wherein the tuned mass-spring system comprises a variable inertia flywheel.
OOO. The method of embodiment MMM or embodiment NNN, wherein the tuned mass-spring system comprises a rotating pendulum.
PPP. The method of any one of embodiments MMM to OOO, wherein the tuned mass-spring system comprises a bifilar pendulum.
QQQ. The method of any one of embodiments MMM to PPP, wherein the tuned mass-spring system comprises a roller-type pendulum.
RRR. The method of any one of embodiments MMM to QQQ, wherein the tuned mass-spring system comprises a ring-type pendulum.
SSS. The method of any one of embodiments MMM to RRR, wherein the tuned mass-spring system comprises a harmonic balancer.
TTT. The method of any one of embodiments MMM to SSS, wherein the tuned mass-spring system comprises a mirroring pump connected to a drive shaft to mirror the multiplex fluid pump.
UUU. The method of embodiment TTT, wherein the mirroring pump of the tuned mass-spring system is unloaded.
VVV. The method of embodiment TTT, wherein the mirroring pump of the tuned mass-spring system is loaded.

WWW. The method of any one of embodiments DDD to VVV, wherein the pump assembly comprises a plurality of harmonic excitation sources, wherein the counteracting resonant system comprises a plurality of stacked vibration absorbers having different oscillatory frequencies, and further comprising selecting and deselecting ones of the vibration absorbers to match an active oscillatory frequency of the harmonic excitation sources.

XXX. The method of embodiment WWW, wherein the stacked vibration absorbers are selectively coupled and decoupled by clutches.
YYY. The method of any one of embodiments DDD to XXX, further comprising selecting one of a plurality of gears in the transmission, wherein the counteracting resonant system comprises a plurality of stacked vibration absorbers coupled to the transmission, and clutching one or more of the stacked vibration absorbers based on the gear selected in the transmission.
ZZZ. The method of any one of embodiments DDD to YYY, wherein the counteracting resonant system absorbs fluctuations of the transferred torque, wherein the counteracting resonant system comprises a plurality of stacked vibration absorbers, and further comprising selecting and deselecting ones of the plurality of stacked vibration absorbers to adjust a magnitude of the torque fluctuation absorption.
AAAA. The pumping method of any one of embodiments DDD to ZZZ, wherein the counteracting resonant system comprises a plurality of stacked vibration absorbers, and further comprising selecting and deselecting ones of the stacked vibration absorbers to selectively adjust a magnitude of the counteracting oscillatory frequency.
BBBB. A pump assembly, comprising:

a prime mover;

a first multiplex fluid pump connected to a drive line;

a transmission connected to transfer torque from the prime mover to rotate the drive line;

a second multiplex fluid pump connected to harmonically mirror the first multiplex pump.

CCCC. The pump assembly of embodiment BBBB, wherein the second multiplex fluid pump is unloaded.
DDDD. A pump assembly, comprising:

a prime mover;

a multiplex fluid pump connected to a drive line;

a transmission connected to transfer torque from the prime mover to rotate the drive line wherein the transmission comprises a plurality of selectable gears;

a source of harmonic excitation originating from one or a combination of any of the prime mover, the multiplex fluid pump, driveline and transmission; and

a plurality of stacked vibration absorbers coupled to the transmission, and

a clutch to selectively engage or disengage each of the stacked vibration absorbers based on the gear selected in the transmission.

The preceding description has been presented with reference to present embodiments. Persons skilled in the art and technology to which this disclosure pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

We claim:

1. A pump assembly, comprising:
a prime mover;
a multiplex fluid pump connected to a drive line;
a transmission connected to transfer torque from the prime mover to rotate the drive line;
a source of harmonic excitation originating from one or a combination of any of the prime mover, the multiplex fluid pump, driveline and transmission; and
a counteracting resonant system coupled to the harmonic excitation source, wherein the counteracting resonant system has an oscillatory frequency matching an oscillatory frequency of the harmonic excitation source.

2. The pump assembly of claim 1, wherein the harmonic excitation source and the counteracting resonant system have matching resonant frequencies.

3. The pump assembly of claim 1, wherein the counteracting resonant system absorbs fluctuations in torque transferred between the prime mover and the multiplex fluid pump.

4. The pump assembly of claim 1 wherein the counteracting resonant system comprises a mirrored pump harmonically matched with respect to the multiplex fluid pump.

5. The pump assembly of claim 1, wherein the counteracting resonant system comprises a tuned mass-spring system.

6. The pump assembly of claim 5, wherein the tuned mass-spring system comprises a variable inertia flywheel, a rotating pendulum, a bifilar pendulum, a roller-type pendulum, a ring-type pendulum, a harmonic balancer, a mirroring multiplex fluid pump to mirror the multiplex fluid pump of the harmonic excitation source or a combination thereof.

7. The pump assembly of claim 1, wherein the counteracting resonant system comprises a plurality of stacked vibration absorbers to selectively adjust a magnitude of the counteracting oscillatory frequency.

8. The pump assembly of claim 7, wherein the stacked vibration absorbers are coupled to the harmonic excitation sources by clutches.

9. The pump assembly of claim 1, comprising a plurality of harmonic excitation sources having a like plurality of resonant frequencies, wherein the counteracting resonant system comprises a plurality of stacked vibration absorbers each having an oscillatory frequency matching an oscillatory frequency of one of the harmonic excitation sources.

10. The pump assembly of claim 1, wherein the transmission comprises a plurality of selectable gears, wherein the counteracting resonant system comprises a plurality of stacked vibration absorbers coupled to the transmission, and wherein one or more of the stacked vibration absorbers are clutched based on the gear selected in the transmission.

11. A method, comprising:
connecting a transmission to transfer torque from a prime mover to rotate a drive line;
connecting the drive line to a multiplex fluid pump to reciprocate a plurality of plungers in a like plurality of cylinders to discharge a pressurized fluid from the pump;
wherein one or a combination of the torque transfer, the drive line rotation and the plunger reciprocation induces harmonic excitation at one or more variable oscillating frequencies;
coupling a counteracting resonant system to the prime mover, the transmission, the driveline, the multiplex fluid pump, or a combination thereof;
tuning the counteracting resonant system to the induced harmonic excitation.

12. The pumping method of claim 11, comprising inhibiting a torsional component of the induced harmonic excitation.

13. The pumping method of claim 11, comprising inhibiting fluctuations up to or above a predetermined magnitude of the torque transferred via the drive line.

14. The pumping method of claim 11, wherein the counteracting resonant system comprises a mirrored pump having a resonant frequency matching a resonant frequency of the multiplex fluid pump.

15. The pumping method of claim 11, wherein the counteracting resonant system comprises a mirrored pump and drive shaft harmonically matched with respect to the multiplex fluid pump and drive line.

16. The pumping method of claim 11, wherein the counteracting resonant system comprises a mirrored pump and drive shaft connecting the mirrored pump to the multiplex fluid pump or transmission.

17. The pumping method of claim 11, wherein the counteracting resonant system comprises a tuned mass-spring system.

18. The pumping method of claim 17, wherein the tuned mass-spring system has a plurality of tuning ratios.

19. The pumping method of claim 17, wherein the tuned mass-spring system comprises another pump connected to a drive shaft to mirror the multiplex fluid pump and the drive line.

20. The pumping method of claim 19, wherein the mirroring pump of the tuned mass-spring system is unloaded.

21. The pumping method of claim 19, further comprising pumping fluid with the mirroring pump of the tuned mass-spring system.

22. The pumping method of claim 11, wherein harmonic excitation is induced at a plurality of different oscillating frequencies, wherein the counteracting resonant system comprises a plurality of stacked vibration absorbers having different oscillatory frequencies, and further comprising selecting and deselecting ones of the vibration absorbers to match an active oscillatory frequency of the harmonic excitation.

23. The pumping method of claim 22, wherein the stacked vibration absorbers are selectively coupled and decoupled by clutches.

24. The pumping method of claim 11, wherein the counteracting resonant system comprises a plurality of stacked vibration absorbers, and further comprising selecting and deselecting ones of the stacked vibration absorbers to selectively adjust a magnitude of the counteracting oscillatory frequency.

25. A method to inhibit vibration of a pump assembly comprising a prime mover, a multiplex fluid pump connected to a drive line, a transmission connected to transfer torque from the prime mover to rotate the drive line and reciprocate a plurality of plungers in a like plurality of cylinders in the fluid pump to discharge a pressurized fluid from the pump, and a source of harmonic excitation, comprising:
coupling a counteracting resonant system to the pump assembly;
wherein the counteracting resonant system has an oscillatory frequency matching an oscillatory frequency of the harmonic excitation source.

26. The method of claim 25, wherein the counteracting resonant system absorbs fluctuations of the transferred torque to inhibit the torque fluctuations up to a predetermined magnitude.

27. The method of claim 25, wherein the counteracting resonant system absorbs fluctuations of the transferred torque to inhibit the torque fluctuations above a predetermined magnitude.

28. The method of claim 25, wherein the counteracting resonant system comprises a mirrored pump harmonically matched with respect to the multiplex fluid pump.

29. A pump assembly, comprising:
a prime mover;
a first multiplex fluid pump connected to a drive line;
a transmission connected to transfer torque from the prime mover to rotate the drive line;
a second multiplex fluid pump connected to harmonically mirror the first multiplex pump.

30. A pump assembly, comprising:
a prime mover;
a multiplex fluid pump connected to a drive line;
a transmission connected to transfer torque from the prime mover to rotate the drive line wherein the transmission comprises a plurality of selectable gears;
a source of harmonic excitation originating from one or a combination of any of the prime mover, the multiplex fluid pump, driveline and transmission; and
a plurality of stacked vibration absorbers coupled to the harmonic excitation source, and
a clutch to selectively engage or disengage each of the stacked vibration absorbers.

31. A pump assembly, comprising:
a prime mover;
a multiplex fluid pump connected to a drive line;
a transmission connected to transfer torque from the prime mover to rotate the drive line wherein the transmission comprises a plurality of selectable gears;
a source of harmonic excitation originating from one or a combination of any of the prime mover, the multiplex fluid pump, driveline and transmission; and
a plurality of stacked vibration absorbers coupled to the transmission, and
a clutch to selectively engage or disengage each of the stacked vibration absorbers based on the gear selected in the transmission.
